(19) United States
(12) Patent Application Publication
(10) Pub. No.: US 2021/0224642 A1
(43) Pub. Date: Jul. 22, 2021

(54) MODEL LEARNING APPARATUS, METHOD AND PROGRAM

(71) Applicant: NIPPON TELEGRAPH AND TELEPHONE CORPORATION, Tokyo (JP)

(72) Inventors: Takafumi MORIYA, Kanagawa (JP); Yoshikazu YAMAGUCHI, Kanagawa (JP)

(73) Assignee: NIPPON TELEGRAPH AND TELEPHONE CORPORATION, Tokyo (JP)

(21) Appl. No.: 15/734,201

(22) PCT Filed: May 27, 2019
(86) PCT No.: PCT/JP2019/020897

§ 371 Date: Dec. 1, 2020

(30) Foreign Application Priority Data
Jun. 5, 2018 (JP) 2018-107643

(51) Int. Cl. G06N 3/08; G06N 3/04

(52) U.S. Cl. CPC G06N 3/08; G06N 3/04

(57) ABSTRACT

A model learning apparatus includes: a model calculation unit that calculates output probability distribution, which is an output from an output layer obtained when each feature amount corresponding to each task j∈1, . . . , J−1 is inputted into a neural network model, where a main task is a task J and sub-tasks are tasks 1, . . . , J−1; and a multi-task type model update unit that updates a parameter of the neural network model so as to minimize a value of a loss function for the each task j∈1, . . . , J−1, the value being calculated based on a correct unit number, which corresponds to each feature amount corresponding to the each task j∈1, . . . , J−1, and the output probability distribution, which is calculated and corresponds to the each task j∈1, . . . , J−1, and subsequently updates a parameter of the neural network model so as to minimize a value of a loss function for the task J, the value being calculated based on a correct unit number, which corresponds to the feature amount corresponding to the task J, and the output probability distribution, which is calculated and corresponds to the task J.

### TECHNICAL FIELD

The present invention relates to a technique for learning a model used for recognizing speech, images, and so forth.

### BACKGROUND ART

A general method for learning a neural network model is described with reference to FIG. 1. A method, employing this learning method, for learning a neural network type model for speech recognition is described, for example, in a section of “TRAINING DEEP NEURAL NETWORKS” in Non-patent Literature 1.

A model learning apparatus in FIG. 1 includes an intermediate feature amount calculation unit 101, an output probability distribution calculation unit 102, and a model update unit 103.

A pair of a feature amount, which is a vector of a real number extracted from each sample of learning data, and a correct unit number corresponding to each feature amount, and an appropriate initial model are prepared in advance. As the initial model, a neural network model obtained by assigning a random number to each parameter and a neural network model which is already learnt with another learning data, for example, can be used.

The intermediate feature amount calculation unit 101 calculates an intermediate feature amount, which facilitates identification of a correct unit in the output probability distribution calculation unit 102, based on an inputted feature amount. An intermediate feature amount is defined by Formula (1) of Non-patent Literature 1. The calculated intermediate feature amount is outputted to the output probability distribution calculation unit 102.

More specifically, assuming that a neural network model is composed of a single input layer, a plurality of intermediate layers, and a single output layer, the intermediate feature amount calculation unit 101 calculates an intermediate feature amount in each of the input layer and the plurality of intermediate layers. The intermediate feature amount calculation unit 101 outputs the intermediate feature amount which is calculated in the last intermediate layer among the plurality of intermediate layers to the output probability distribution calculation unit 102.

The output probability distribution calculation unit 102 inputs the intermediate feature amount, which is finally calculated in the intermediate feature amount calculation unit 101, into the output layer of the current model so as to calculate output probability distribution which arranges probabilities corresponding to respective units of the output layer. The output probability distribution is defined by Formula (2) of Non-patent Literature 1. The calculated output probability distribution is outputted to the model update unit 103.

The model update unit 103 calculates a value of a loss function based on the correct unit number and the output probability distribution and updates the model to lower the value of the loss function. The loss function is defined by Formula (3) of Non-patent Literature 1. The model updating by the model update unit 103 is performed based on Formula (4) of Non-patent Literature 1.

The above-described processing of extracting an intermediate feature amount, calculating output probability distribution, and updating the model is repeated for each pair of a feature amount of learning data and a correct unit number, and a model obtained when the predetermined number of times of the processing repetition is completed is used as a learnt model. The predetermined number of times is generally from tens of millions to hundreds of millions of times.

Non-patent Literature 2 describes a method for learning a plurality of tasks, which are different from a main task, and the main task in parallel so as to improve performance with respect to the main task which is to be finally solved. This learning method is called multi-task learning and has been reported to be improved in performance thereof in various fields.

A model learning apparatus performing the multi-task learning of Non-patent Literature 2 is described with reference to FIG. 2.

The model learning apparatus in FIG. 2 includes an intermediate feature amount calculation unit 101, an output probability distribution calculation unit 102, and a multi-task type model update unit 201 in a similar manner to the model learning apparatus in FIG. 1. Processing of the intermediate feature amount calculation unit 101 and the output probability distribution calculation unit 102 in FIG. 2 is the same as processing of the intermediate feature amount calculation unit 101 and the output probability distribution calculation unit 102 in FIG. 1, so that duplicate description thereof is omitted.

To the multi-task type model update unit 201, output probability distribution of each feature amount of each task j∈1, . . . , J, a correct unit number corresponding to each feature amount, and a hyper parameter λⱼ are inputted, where J is an integer which is 2 or greater. The hyper parameter λⱼ is a weight parameter representing a level of importance of a task and is manually set.

The multi-task type model update unit 201 performs learning so as to minimize a sum L of values which are obtained by multiplying a value Lⱼ of a loss function for each task by a hyper parameter λⱼ∈[0,1]. The value Lⱼ of the loss function is obtained based on the output probability distribution of each feature amount of each task j∈1, . . . , J and the correct unit number corresponding to each feature amount.

$$L = {\sum }_{j = 1}^{J} {λ}_{j} {L}_{j}$$

Thus, by solving interacting tasks in parallel, improvement in recognition performance is expected.

### PRIOR ART LITERATURE

### Non-Patent Literature

Non-patent Literature 1: Geoffrey Hinton, Li Deng, Dong Yu, George E. Dahl, Abdel-rahman Mohamed, Navdeep Jaitly, Andrew Senior, Vincent Vanhoucke, Patric Nguyen, Tara N. Sainath and Brian Kingsbury, “Deep Neural Networks for Acoustic Modeling in Speech Recognition,” IEEE Signal Processing Magazine, Vol. 29, No 6, pp. 82-97, 2012.
Non-patent Literature 2: Yanmin Qian, Tian Tan, Dong Yu, and Yu Zhang, “INTEGRATED ADAPTATION WITH MULTI-FACTOR JOINT-LEARNING FOR FAR-FIELD SPEECH RECOGNITION,” ICASSP, pp. 5770-5774, 2016

### SUMMARY OF THE INVENTION

### Problems to be Solved by the Invention

In Non-patent Literature 2, learning is performed so as to minimize the sum L of values which are obtained by multiplying the value Lⱼ of a loss function for each task by the weight λⱼ∈[0,1].

$$L = {\sum }_{j = 1}^{J} {λ}_{j} {L}_{j}$$

Such minimization of the sum L enables learning to be performed so that the entire loss is minimized, but this learning is not designed as individual tasks are explicitly minimized because L is a weighted sum. The technique of Non-patent Literature 2 has had room for improvement on this point.

An object of the present invention is to provide a model learning apparatus, method, and program for model learning in which performance with respect to a finally-solved task is improved over the related art.

### Means to Solve the Problems

According to one aspect of the present invention, a model learning apparatus includes: a model calculation unit that calculates output probability distribution, the output probability distribution being an output from an output layer obtained when each feature amount corresponding to each task j∈1, . . . , J−1 is inputted into a neural network model, where J is a predetermined integer being 2 or greater, a main task is a task J, and sub-tasks whose number is at least one and which are required for performing the main task are tasks 1, . . . , J−1; and a multi-task type model update unit that updates a parameter of the neural network model so as to minimize a value of a loss function for the each task j∈1, . . . , J−1, the value being calculated based on a correct unit number and the output probability distribution, the correct unit number corresponding to each feature amount corresponding to the each task j∈1, . . . , J−1, the output probability distribution being calculated and corresponding to the each task j∈1, . . . , J−1, and subsequently updates a parameter of the neural network model so as to minimize a value of a loss function for the task J, the value being calculated based on a correct unit number and the output probability distribution, the correct unit number corresponding to the feature amount corresponding to the task J, the output probability distribution being calculated and corresponding to the task J.

### Effects of the Invention

By explicitly minimizing each of values of loss functions for tasks other than a finally-solved task, performance in the finally-solved task can be improved over the related art.

### BRIEF DESCRIPTION OF THE DRAWINGS

FIG. 1 is a diagram illustrating an example of a functional configuration of a model learning apparatus of Non-patent Literature 1.

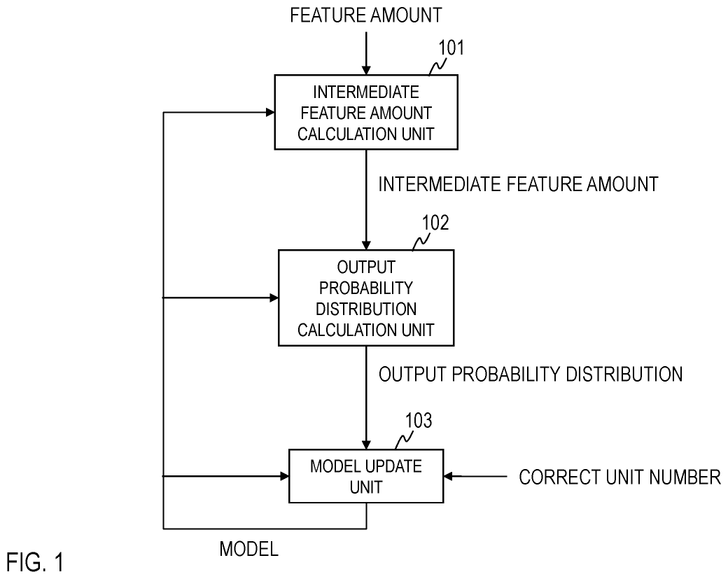

FIG. 2 is a diagram illustrating an example of a functional configuration of a model learning apparatus of Non-patent Literature 2.

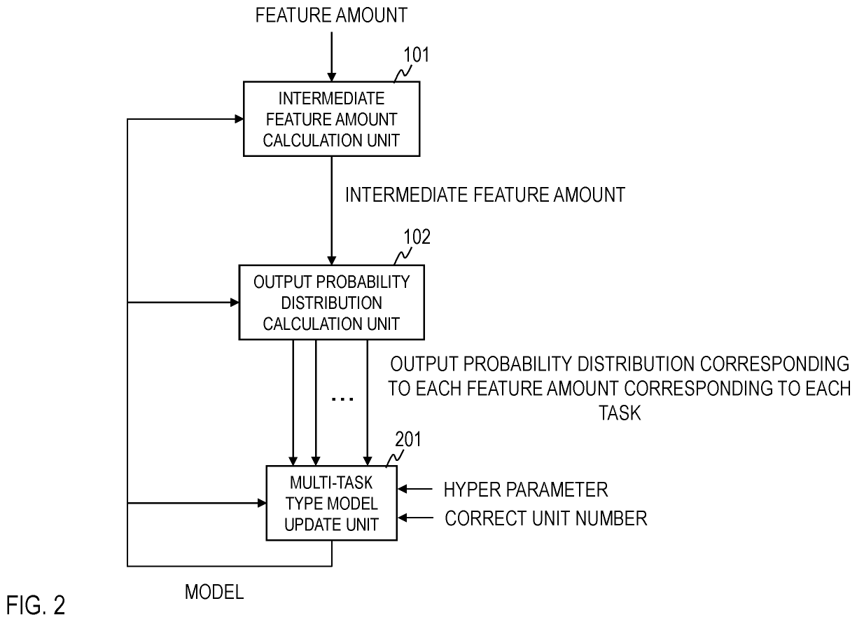

FIG. 3 is a diagram illustrating an example of a functional configuration of a model learning apparatus according to the present invention.

FIG. 4 is a diagram illustrating an example of a functional configuration of a multi-task type model update unit 31 according to the present invention.

FIG. 5 is a diagram illustrating an example of a processing procedure of a model learning method.

FIG. 6 is a diagram illustrating a functional configuration example of a computer.

### DETAILED DESCRIPTION OF THE EMBODIMENTS

An embodiment according to the present invention is described in detail below. It is to be noted that components mutually having the same function are identified with the same reference numeral in the drawings and duplicate description thereof is omitted.

[Model Learning Apparatus and Method]

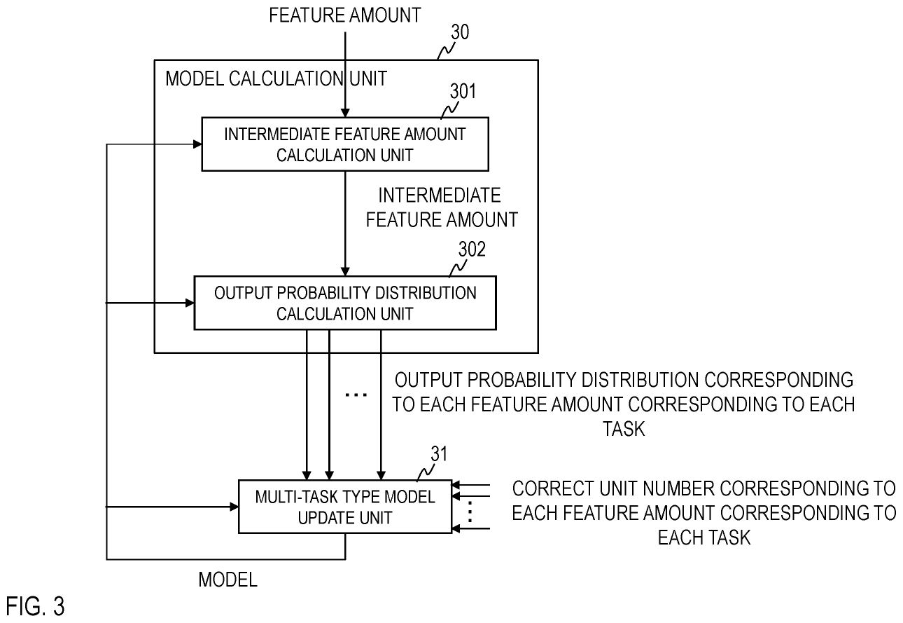

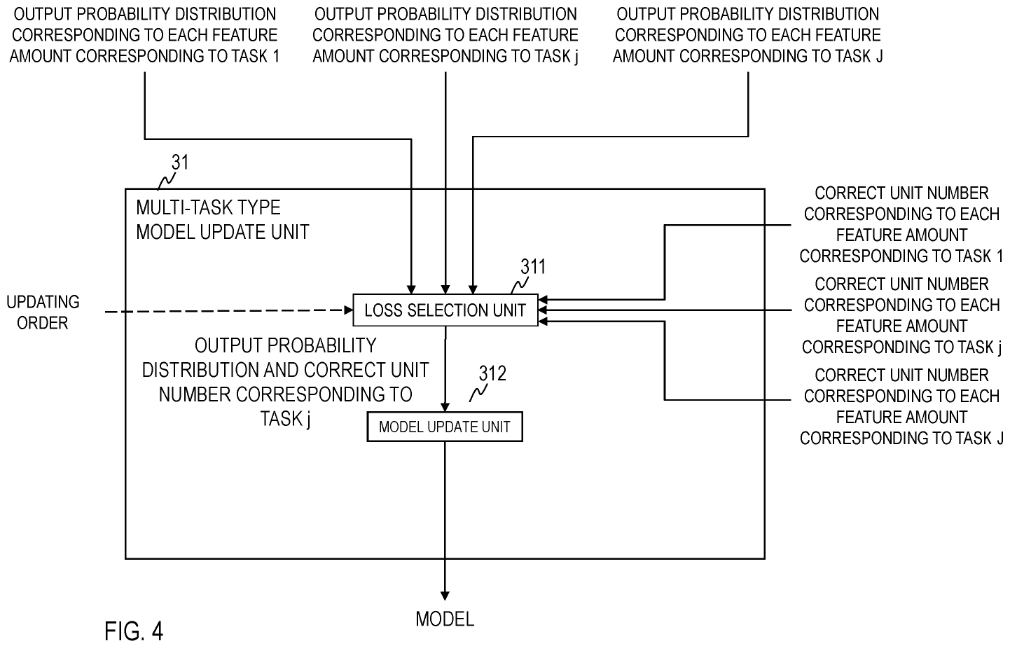

A model learning apparatus includes, for example, a model calculation unit 30 and a multi-task type model update unit 31 as illustrated in FIG. 3. The model calculation unit 30 includes, for example, an intermediate feature amount calculation unit 301 and an output probability distribution calculation unit 302. The multi-task type model update unit 31 includes, for example, a loss selection unit 311 and a model update unit 312 as illustrated in FIG. 4.

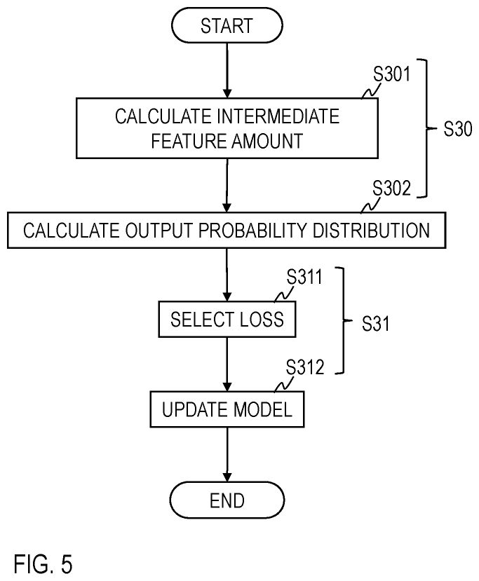

The model learning method is realized, for example, by performing processing steps S30 and S31, which are described below and are illustrated in FIG. 5, by each component of the model learning apparatus.

It is assumed that: a main task is a task J; sub-tasks whose number is at least one and which are required for performing the main task are tasks 1, . . . , J−1; and a pair of a feature amount, which is a vector of a real number extracted from each sample of learning data for each task 1, . . . , J, and a correct unit number corresponding to each feature amount and a neural network model being an appropriate initial model are prepared before performing processing described below. As the neural network model being the initial model, a neural network model obtained by assigning a random number to each parameter and a neural network model which is already learnt with another learning data, for example, can be used.

Sub-tasks whose number is at least one and which are required for performing the main task are tasks related to the main task. The sub-tasks whose number is at least one are mutually-related tasks.

Examples of the main task and the sub-tasks whose number is at least one include the main task=word recognition, the sub-task 1=monophone recognition, the sub-task 2=triphone recognition, and the sub-task 3=recognition of katakana.

Other examples of the main task and the sub-tasks whose number is at least one include the main task=image recognition including character recognition and the sub-task 1=character recognition based on an image including only characters.

Each component of the model learning apparatus is described below.

<Model Calculation Unit 30>

A feature amount corresponding to each task j∈1, . . . , J is inputted into the model calculation unit 30.

The model calculation unit 30 calculates output probability distribution which is an output from the output layer obtained when each feature amount corresponding to each task j∈1, . . . , J is inputted into the neural network model.

The calculated output probability distribution is outputted to the multi-task type model update unit 31.

The intermediate feature amount calculation unit 301 and the output probability distribution calculation unit 302 of the model calculation unit 30 will be described below so as to describe the processing of the model calculation unit 30 in detail.

The processing, described below, of the intermediate feature amount calculation unit 301 and the output probability distribution calculation unit 302 is performed to each feature amount corresponding to each task j∈1, . . . , J. Accordingly, output probability distribution corresponding to each feature amount corresponding to each task j∈1, . . . , J can be obtained.

<<Intermediate Feature Amount Calculation Unit 301>>>

The intermediate feature amount calculation unit 301 performs processing similar to that of the intermediate feature amount calculation unit 101.

A feature amount is inputted into the intermediate feature amount calculation unit 301.

The intermediate feature amount calculation unit 301 generates an intermediate feature amount by using the inputted feature amount and a neural network model being the initial model (step S301). An intermediate feature amount is defined by, for example, Formula (1) of Non-patent Literature 1.

The calculated intermediate feature amount is outputted to the output probability distribution calculation unit 302.

The intermediate feature amount calculation unit 301 calculates an intermediate feature amount, which facilitates identification of a correct unit in the output probability distribution calculation unit 302, based on the inputted feature amount and the neural network model. Specifically, assuming that the neural network model is composed of a single input layer, a plurality of intermediate layers, and a single output layer, the intermediate feature amount calculation unit 301 calculates an intermediate feature amount in each of the input layer and the plurality of intermediate layers. The intermediate feature amount calculation unit 301 outputs the intermediate feature amount which is calculated in the last intermediate layer among the plurality of intermediate layers to the output probability distribution calculation unit 302.

<<Output Probability Distribution Calculation Unit 302>>>

The output probability distribution calculation unit 302 performs processing similar to that of the output probability distribution calculation unit 102.

The intermediate feature amount calculated by the intermediate feature amount calculation unit 301 is inputted into the output probability distribution calculation unit 302.

The output probability distribution calculation unit 302 inputs the intermediate feature amount, which is finally calculated in the intermediate feature amount calculation unit 301, into the output layer of the neural network model so as to calculate output probability distribution which arranges probabilities corresponding to respective units of the output layer (step S302). The output probability distribution is defined by, for example, Formula (2) of Non-patent Literature 1.

The calculated output probability distribution is outputted to the multi-task type model update unit 31.

For example, when the inputted feature amount is a speech feature amount and the neural network model is a neural network type sound model for speech recognition, the output probability distribution calculation unit 302 calculates which speech output symbol (phoneme state) an intermediate feature amount, facilitating identification of the speech feature amount, represents. In other words, output probability distribution corresponding to the inputted speech feature amount is obtained.

<Multi-Task Type Model Update Unit 31>

To the multi-task type model update unit 31, a correct unit number corresponding to each feature amount corresponding to each task j∈1, . . . , J−1 and output probability distribution corresponding to each feature amount corresponding to each task j∈1, . . . , J calculated by the model calculation unit 30 are inputted.

The multi-task type model update unit 31 updates a parameter of the neural network model so as to minimize a value of a loss function for each task j∈1, . . . , J−1, the value being calculated based on a correct unit number, which corresponds to each feature amount corresponding to the each task j∈1, . . . , J−1, and output probability distribution, which corresponds to the each task j∈1, . . . , J−1 and is calculated in the model calculation unit 30; and the multi-task type model update unit 31 subsequently updates a parameter of the neural network model so as to minimize a value of a loss function for the task J, the value being calculated based on a correct unit number, which corresponds to a feature amount corresponding to the task J, and output probability distribution, which corresponds to the task J and is calculated in the model calculation unit 30 (step S31).

The loss selection unit 311 and the model update unit 312 of the multi-task type model update unit 31 will be described below so as to describe the processing of the multi-task type model update unit 31 in detail.

<<Loss Selection Unit 311>>

To the loss selection unit 311, a correct unit number corresponding to each feature amount corresponding to each task j∈1, . . . , J−1 and output probability distribution calculated by the model calculation unit 30 and corresponding to each feature amount corresponding to each task j∈1, . . . , J are inputted.

The loss selection unit 311 outputs the correct unit number corresponding to each feature amount corresponding to each task j∈1, . . . , J−1 and the output probability distribution calculated by the model calculation unit 30 and corresponding to each feature amount corresponding to each task j∈1, . . . , J to the model update unit 312 in a predetermined order (step S311).

Hereinafter, assuming that j=1, . . . , J, a correct unit number corresponding to each feature amount corresponding to a task j and output probability distribution calculated by the model calculation unit 30 and corresponding to each feature amount corresponding to the task j are simply referred to as information corresponding to the task j.

Regarding the predetermined order, any order may be employed for outputting information corresponding to tasks 1, . . . , J−1 other than the task J as long as information corresponding to the task J is outputted at the end of the order. The number of pieces of predetermined order can be (J−1)! pieces. For example, the predetermined order is an order other than the ascending order for the tasks 1, . . . , J−1.

The predetermined order is preliminarily set and inputted into the loss selection unit 311, for example. If the predetermined order is not preliminarily set, the loss selection unit 311 may determine the predetermined order.

When the main task=word recognition, the sub-task 1=monophone recognition, the sub-task 2=triphone recognition, and the sub-task 3=recognition of katakana, for example, information corresponding to each of the sub-task 1 to the sub-task 3 is first outputted to the model update unit 312 and information corresponding to a main task to be finally solved is outputted to the model update unit 312.

<<Model Update Unit 312>>

To the model update unit 312, the correct unit number corresponding to each feature amount corresponding to each task j∈1, . . . , J−1 and the output probability distribution corresponding to each feature amount corresponding to each task j∈1, . . . , J, the correct unit number and the output probability distribution being outputted by the loss selection unit 311 in a predetermined order, are inputted.

The model update unit 312 updates a parameter of the neural network model so as to minimize a value of a loss function for a task, the value being calculated based on a correct unit number corresponding to each feature amount corresponding to the task and output probability distribution corresponding to each feature amount corresponding to the task, for each task, in an inputted task order (step S312).

The loss function is defined by Formula (3) of Non-patent Literature 1, for example. The model updating by the model update unit 312 is performed based on Formula (4) of Non-patent Literature 1, for example. Parameters in the model to be updated are weight w and bias b of Formula (1) of Non-patent Literature 1, for example.

The task J is the last in the predetermined order, for example, so that the model update unit 312 first performs parameter updating of the neural network model so as to minimize a value of the loss function for each task j∈1, . . . , J−1. Then, the model update unit 312 performs parameter updating of the neural network model so as to minimize a value of the loss function for the task J.

Thus, each of loss functions for tasks other than a finally-solved task is explicitly minimized, being able to improve performance in the finally-solved task over the related art.

[Modifications]

While the embodiment of the present invention has been described, the specific configuration is not limited to the embodiment, but design modifications and the like within a range not departing from the spirit of the invention are encompassed in the scope of the invention, of course.

The various processes described in the embodiment may be executed in parallel or separately depending on the processing ability of an apparatus executing the process or on any necessity, rather than being executed in time series in accordance with the described order.

[Program and Recording Medium]

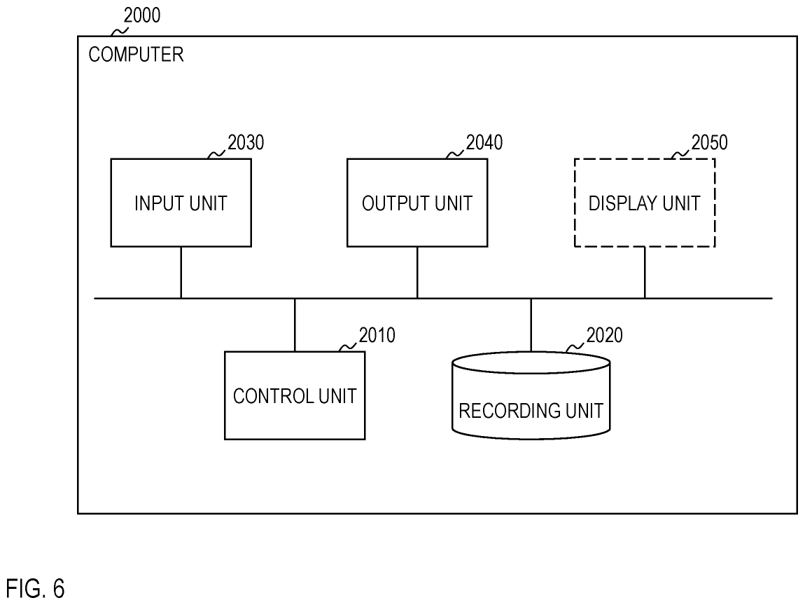

The above-described various processes can be executed by making a recording unit 2020 of a computer illustrated in FIG. 6 read a program for execution of each step in the above-described method and making a control unit 2010, an input unit 2030, an output unit 2040, and so forth operate.

This program in which the contents of processing are written can be recorded in a computer-readable recording medium. The computer-readable recording medium may be any medium such as a magnetic recording device, an optical disk, a magneto-optical recording medium, and a semiconductor memory.

Distribution of this program is implemented by sales, transfer, rental, and other transactions of a portable recording medium such as a DVD and a CD-ROM on which the program is recorded, for example. Furthermore, this program may be stored in a storage unit of a server computer and transferred from the server computer to other computers via a network so as to be distributed.

A computer which executes such program first stores the program recorded in a portable recording medium or transferred from a server computer once in a storage unit thereof, for example. When the processing is performed, the computer reads out the program stored in the storage unit thereof and performs processing in accordance with the program thus read out. As another execution form of this program, the computer may directly read out the program from a portable recording medium and perform processing in accordance with the program. Furthermore, each time the program is transferred to the computer from the server computer, the computer may sequentially perform processing in accordance with the received program. Alternatively, a configuration may be adopted in which the transfer of a program to the computer from the server computer is not performed and the above-described processing is executed by so-called application service provider (ASP)-type service by which the processing functions are implemented only by an instruction for execution thereof and result acquisition. It should be noted that a program in this form includes information which is provided for processing performed by electronic calculation equipment and which is equivalent to a program (such as data which is not a direct instruction to the computer but has a property specifying the processing performed by the computer).

In this form, the present apparatus is configured with a predetermined program executed on a computer. However, the present apparatus may be configured with at least part of these processing contents realized in a hardware manner.

### DESCRIPTION OF REFERENCE NUMERALS

101 intermediate feature amount calculation unit
102 output probability distribution calculation unit
103 model update unit
201 multi-task type model update unit
30 model calculation unit
301 intermediate feature amount calculation unit
302 output probability distribution calculation unit
31 multi-task type model update unit
311 loss selection unit
312 model update unit

1. A model learning apparatus comprising:
a hardware processor that:
calculates output probability distribution, the output probability distribution being an output from an output layer obtained when each feature amount corresponding to each task j∈1, . . . , J is inputted into a neural network model, where J is a predetermined integer being 2 or greater, a main task is a task J, and sub-tasks whose number is at least one and which are required for performing the main task are tasks 1, . . . , J−1; and
updates a parameter of the neural network model so as to minimize, for each task, a value of a loss function for the each task j∈1, . . . , J−1, the value being calculated based on a correct unit number and the output probability distribution, the correct unit number corresponding to each feature amount corresponding to the each task j∈1, . . . , J−1, the output probability distribution being calculated and corresponding to the each task j∈1, . . . , J−1, and subsequently updates a parameter of the neural network model so as to minimize a value of a loss function for the task J, the value being calculated based on a correct unit number and the output probability distribution, the correct unit number corresponding to the feature amount corresponding to the task J, the output probability distribution being calculated and corresponding to the task J.

2. A model learning apparatus comprising:
a hardware processor that:
calculates output probability distribution, the output probability distribution being an output from an output layer obtained when each feature amount corresponding to each task j∈1, . . . , J is inputted into a neural network model, where J is a predetermined integer being 2 or greater, and sub-tasks whose number is at least one and which are required for performing a task J are tasks 1, . . . , J−1; and
updates a parameter of the neural network model so as to minimize, for each task, a value of a loss function for the each task j∈1, . . . , J, the value being calculated based on a correct unit number and the output probability distribution, the correct unit number corresponding to each feature amount corresponding to the each task j∈1, . . . , J, the output probability distribution being calculated and corresponding to the each task j∈1, . . . , J.

3. The model learning apparatus according to claim 1 or 2, wherein
the model update unit performs parameter updating of the neural network model so as to minimize, for each task, the value of the loss function for the each task j∈1, . . . , J−1 in an order other than an ascending order for the tasks 1, . . . , J−1.

4. The model learning apparatus according to claim 1 or 2, wherein
the model update unit performs parameter updating of the neural network model so as to minimize, for each task, the value of the loss function for the each task j∈1, . . . , J−1 in an order other than an ascending order for the tasks 1, . . . , J−1.

5. A model learning method comprising:
a model calculation step in which a model calculation unit calculates output probability distribution, the output probability distribution being an output from an output layer obtained when each feature amount corresponding to each task j∈1, . . . , J is inputted into a neural network model, where J is a predetermined integer being 2 or greater, a main task is a task J, and sub-tasks whose number is at least one and which are required for performing the main task are tasks 1, . . . , J−1; and
a multi-task type model updating step in which a multi-task type model update unit updates a parameter of the neural network model so as to minimize, for each task, a value of a loss function for the each task j∈1, . . . , J−1, the value being calculated based on a correct unit number and the output probability distribution, the correct unit number corresponding to each feature amount corresponding to the each task j∈1, . . . , J−1, the output probability distribution being calculated and corresponding to the each task j∈1, . . . , J−1, and subsequently updates a parameter of the neural network model so as to minimize a value of a loss function for the task J, the value being calculated based on a correct unit number and the output probability distribution, the correct unit number corresponding to the feature amount corresponding to the task J, the output probability distribution being calculated and corresponding to the task J.

6. A model learning method comprising:
a model calculation step in which a model calculation unit calculates output probability distribution, the output probability distribution being an output from an output layer obtained when each feature amount corresponding to each task j∈1, . . . , J is inputted into a neural network model, where J is a predetermined integer being 2 or greater, and sub-tasks whose number is at least one and which are required for performing a task J are tasks 1, . . . , J−1; and
a multi-task type model updating step in which a multi-task type model update unit updates a parameter of the neural network model so as to minimize, for each task, a value of a loss function for the each task j∈1, . . . , J, the value being calculated based on a correct unit number and the output probability distribution, the correct unit number corresponding to each feature amount corresponding to the each task j∈1, . . . , J, the output probability distribution being calculated and corresponding to the each task j∈1, . . . , J−1.

7. The model learning method according to claim 5 or 6, wherein
in the model updating step, parameter updating of the neural network model is performed so as to minimize, for each task, the value of the loss function for the each task j∈1, . . . , J−1 in an order other than an ascending order for the tasks 1, . . . , J−1.

8. A non-transitory computer readable medium that stores a program for making a computer function as each unit of the model learning apparatus according to claim 1 or 2.
